(19) United States
(12) Patent Application Publication
(10) Pub. No.: US 2005/0246165 A1
(43) Pub. Date: Nov. 3, 2005

(54) System and method for analyzing and improving a discourse engaged in by a number of interacting agents

(76) Inventors: Eugene E. Pettinelli, Sudbury, MA (US); Daniel Alexander, Roxbury, MA (US)

Correspondence Address: FISH & NEAVE IP GROUP;ROPES & GRAY LLP, ONE INTERNATIONAL PLACE, BOSTON, MA, 02110-2624, US

(21) Appl. No.: 11/005,872

(22) Filed: Dec. 6, 2004

Related U.S. Application Data
(60) Provisional application No. 60/566,482, filed on Apr. 29, 2004.

(51) Int. Cl. G10L 11/04

(52) U.S. Cl. 704/207

(57) ABSTRACT

A computerized method of analyzing a discourse engaged in by a plurality of interacting agents includes measuring a first set of prosodic features associated with the discourse and, at least partially based on the first set of measured prosodic features, determining a target set of prosodic features that are likelier to be associated with a target state and/or characteristic of the discourse than the first set of prosodic features. The method optionally includes providing the agents with feedback aimed at steering the discourse toward a desirable outcome. Optionally, the method includes imposing a constraint on a subset of the agents to force a behavioral modification upon the subset of the agents to increase the likelihood of the desirable outcome.

### CROSS-REFERENCE TO RELATED APPLICATIONS

This application incorporates by reference in entirety, and claims priority to and benefit of, U.S. Provisional Patent Application No. 60/566,482, filed on 29 Apr. 2004.

### BACKGROUND

Research into the use of computers to understand what people communicate to one another, and how, has a long and deep history. Principally, the research has been conducted in the laboratories of large private and public corporations, governments, and universities. Progress has been made in such areas as linguistic analysis, non-verbal signaling, and speech recognition. Recent advances in the application of linked Hidden Markov Models (S. Basu, “Conversational Scene Analysis”, Ph.D. Thesis, MIT, September 2002), and, in particular, the application of such techniques as the “Influence Model” (C. Asavathiratham, “The Influence Model: A Tractable Representation for the Dynamics of Networked Markov Chains”, Ph.D. Thesis, MIT, October 2000), as applied to constructing the dynamics of interacting agents (T. Choudhury et al., “Learning Communities: Connectivity and Dynamics of Interacting Agents”, MIT Media Lab Technical Report TR#560, also in the Proceedings of the International Joint Conference on Neural Networks—Special Session on Autonomous Mental Development, July 2003), and Detrended Fluctuation Analysis (S. Basu, Ibid), have opened the field to new applications, which prior technologies were inadequately equipped to address.

A key advancement in this area is the application of quasi-syntactic analysis to verbal and non-verbal communication, which can yield insightful data without the burden of semantic determination of the content of an interaction. This work falls within the larger field of conversational scene analysis where prosodic cues are employed to identify an emotional state of an individual. Systems of this type have been assembled at institutions such as the Speech Technology and Research Laboratory at the Stanford Research Institute (SRI) and at the MIT Media Laboratory.

Commercial systems embodying various technologies seeking to determine emotional and/or semantic content have begun to appear on the market, for example, Utopy and Nemesyco. However, in the absence of syntactic and/or semantic voice content data, determining emotional states or stylistic non-content-based features of an interactive discourse to a reasonable accuracy is a hard problem; it requires a common-sense understanding of the discourse and an accurate application of context, and is a problem that has not lent itself well to computer automation.

### SUMMARY OF THE INVENTION

To date, it has proven difficult to incorporate into a computer algorithm a human-like understanding of people-to-people communications of even the most elementary forms. The prior art has not solved the hard problem of common-sense reasoning, or assignment of the proper context to data streams obtained from daily exchanges of information among people.

Furthermore, the prior art does not provide a computerized system or method of using non-content-based cues to analyze a discourse, much less provide a means of conveying feedback to interacting participants in a discourse to move the discourse toward a desirable outcome. There is therefore a need for improved computerized methods of analyzing a discourse engaged in by interacting agents, such as conversing humans, the methods based at least partially on a combination of auditive and/or visual prosodic cues associated with the discourse.

The systems and methods described herein provide, in various ways, technologies related to discourse and/or behavior analysis in general, and conversational scene analysis in particular. In various embodiments, the systems and methods of the invention analyze a discourse based on prosodic cues, for example, and without limitation: spectral entropy, probabilistic pitch tracking, voicing segmentation, adaptive energy-based analysis, neural networks for determining appropriate thresholds, noisy autocorrelograms, and Viterbi algorithms for Hidden Markov Models, among others. Technologies that probe more deeply into the underlying structure of information in a human interaction show promise in enhancing the information, and may be used to supplement the analysis. For example, spectro-temporal response field functions for determining an individual's unique encoding of conversational speech (S. Basu, Ibid) may be employed to augment the conversational scene data collected from the audio and visual inputs of the systems and methods described herein.

The ability to measure styles of interaction among interacting individuals has many applications. These include, but are not limited to: teenagers wishing to improve their conversational image with one another; sales organizations hoping to improve their close rate with customers; and support personnel who wish to shorten the time of interaction with their clients while maintaining the quality of the support. Other applications include augmenting the types and amounts of information of real-time and non-real-time online social networking applications.

In one embodiment, the systems and methods described herein allow service providers to offer to subscribers quantitative and/or qualitative information aimed at helping determine the nature and effectiveness of communications among the subscribers and/or between the providers and the subscribers.

In an alternative embodiment, the systems and methods described herein provide the ability for customer sales and service departments to improve their operations and increase sales closing probabilities by giving them quantitative and/or qualitative information to facilitate determination of the nature of the communications between and among them and their customers. According to various practices, this information can be used for many other useful purposes to improve, or optimize, interactions, such as by reducing the amount of time spent in a conversation, improving the quality and/or flow of an interaction, or otherwise increasing the likelihood of a successful outcome or maintaining the interaction at a desirable state or within a range of states.

According to one practice, using a combination of a caller's name, phone number, zip code, and other indicia solicited, obtained, or inferred from the caller—for example, through an automated voice menu system prompting a caller to input certain relevant information—the nature of the call (request literature, open an account, etc.), and account information (if applicable), assumptions and inferences can be made about the caller's style of interaction, the context of the interaction, and one or more objectives of the interaction. Examples of contextual dependence of service rendering include sales and post-sales support; a caller requesting sales information about, for example, a computer that he or she may be interested in purchasing has needs that are ordinarily distinct from a customer who calls the manufacturer or an authorized dealer requesting repair or other post-sales service.

If a record exists of a previous call by the caller, then behavioral information associated with the record—such as, for example, information about an interactive style of the caller—might be available as a starting point, an initialization stage, for the systems and methods described herein. If no historical information is available about the individual caller, then according to one practice, the systems and methods disclosed herein refer to archived behavioral prototypes that most closely approximate the context and profile of the caller. The prototype information is then used, according to this practice, as a benchmark in evaluating and proceeding with the analysis of the caller's present interaction and/or guiding the discourse of the call in a desirable direction. The archived behavioral prototypes may be stored in a database accessible to a computer system implementing the methods according to the invention.

Actual and/or estimated caller information (perhaps obtained automatically from a database, or solicited from the caller through a sequence of menu-driven auditive and/or visual options and prompts), may then be used to match the caller to a service agent likely to have a productive interaction with the caller. According to one practice, when the caller calls, he or she is presented with a sequence of one or more menu options, during a subset of which the caller is prompted to enter relevant information; for example, the caller may be presented with an audio prompt as follows: “Please enter your account number,” or “Please enter your social security number.” As the call proceeds, the systems and methods described herein evaluate the call to determine whether it is likely to lead to a desired outcome for this type of call; the call-taker is advised on how to change the style, nature, or content of the interaction to move the conversation in a direction, or shift the conversation to a state, expected to increase the likelihood of a desired outcome. For example, the call-taker may be instructed to explain to the caller why the caller should open an IRA, make an additional IRA investment, purchase an annuity, etc. Although the embodiment above is described in terms of an incoming call, the systems and methods described herein work in substantially the same way in the context of an outgoing call.

According to one aspect, the systems and methods described herein provide a computerized method of analyzing a discourse engaged in by a plurality of interacting agents. The method includes the steps of measuring a first set of prosodic features associated with the discourse, during a first time interval; and at least partially based on the first set of features, determining a target set of prosodic features, wherein the target set is likelier to be associated with a target state of the discourse than the first set. According to one embodiment, the method includes suggesting to a subset of the agents, for example, by a feedback mechanism, a prosodic behavior for increasing a likelihood of producing the target state. In one embodiment, the method includes predicting a state of the discourse based at least partially on the first set of prosodic features; optionally, and based at least partially on the predicted state, the method includes suggesting to a subset of the agents a prosodic behavior for increasing a likelihood of producing the target state.

In one aspect, the systems and methods described herein include a computerized method of analyzing a discourse engaged in by a plurality of interacting agents, wherein the method includes the steps of: measuring a first set of prosodic features associated with the discourse, during a first time interval; and at least partially based on the first set of features, conveying to a subset of the agents a prosodic behavior for increasing a likelihood of producing a target state of the discourse.

In another aspect, the systems and methods described herein include a computerized method of analyzing a discourse engaged in by a plurality of interacting agents, the method comprising the steps of: measuring a first set of prosodic features associated with the discourse, during a first time interval; at least partially based on the first set of features, determining a first state of the discourse associated with the first set; and determining a change in the first set of features likely to incline the discourse away from the first state and toward a target state.

In yet another aspect, the systems and methods described herein include a computerized method of selecting a subset of agents to participate in a discourse, the method comprising the steps of: profiling a prosodic behavior of the agents based on at least one previous discourse engaged in by at least one of the agents; and based at least partially on the profiling, selecting the subset of the agents having an associated prosodic behavior likely to produce a target state of the discourse.

Further features and advantages of the invention will be apparent from the following description of illustrative embodiments, and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 depicts an embodiment of a two-person discourse;

FIG. 2 depicts an embodiment of the two-person discourse, illustrating in greater detail the feedback mechanism;

FIG. 3 depicts an embodiment of a multi-party interactive discourse;

FIG. 4 depicts an embodiment of an illustrative functional workflow employed in the analysis of the discourse; and

FIG. 5 depicts in greater detail the organizational structure of decision elements in FIG. 4.

### DETAILED DESCRIPTION OF THE ILLUSTRATED EMBODIMENTS

To provide an overall understanding of the invention, certain illustrative practices and embodiments will now be described, including a method for analyzing a discourse engaged in by a plurality of interacting agents and a system for doing the same. The systems and methods described herein can be adapted, modified, and applied to other contexts; such other additions, modifications, and uses will not depart from the scope hereof.

In one aspect, the systems and methods disclosed herein are directed at improving interpersonal productivity and/or compatibility. According to one practice, the invention includes implementing conversational scene analysis on a computer having a processor, a memory, and one or more interfaces used for receiving data from, or sending data to, a number of interacting agents (typically, but not necessarily, humans) engaged in the discourse. According to this aspect, a system presents a result of the analysis to one or more interested parties—which may include one or more of the interacting agents—via a combination of a mobile phone, a personal digital assistant, and another device configured for such purpose, and enabled with a combination of voice (e.g., a speaker or other audio outlet), tactile (a vibration mechanism, as in a mobile phone), visual (e.g., a web browser or other screen), and other interfaces.

Optionally, the system according to this aspect conveys feedback to a subset of the agents, the feedback being directed at altering a behavior of the subset of the agents, thereby inclining the discourse away from an undesirable outcome, toward a desirable outcome, maintaining a status quo, or a combination thereof. The feedback may be conveyed to the subset of the agents in a number of ways: auditive feedback, visual feedback, tactile feedback, olfactory feedback, gustatory feedback, synthetically-generated feedback (such as, for example, a computerized message or prompt), mechanical or other physical feedback, electrical feedback, a generally sensory feedback (such as, for example, a feedback that may stimulate a biometric characteristic of an agent), and a combination thereof.

In one aspect, the systems and methods described herein extend and implement these and other concepts for application to practical everyday settings of commercial and consumer use.

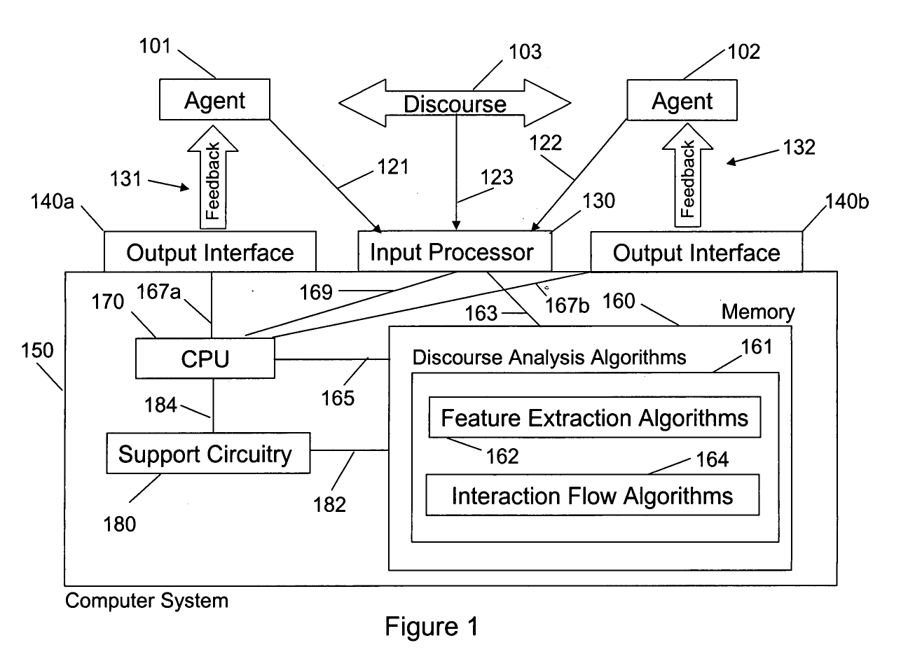

FIG. 1 depicts an exemplary embodiment of the systems and methods described herein; the illustrative context includes a discourse involving a two-agent interaction. Although the description is focused on interacting human agents, it should be understood that in various embodiments, the agents may include a combination of humans, animals, and synthetically-generated agents; examples of synthetically-generated agents include, without limitation, robots, voice synthesis or voice response systems, computer-generated animated figures, having perhaps a cartoon-like, human-like or other visual representation, and which may be “programmed” with intelligence, or which may be configured to learn from present and/or past data to determine a present and/or future behavior, employing, for example, neural networks.

According to a typical practice, the interaction characterizing the discourse 103 is predominantly speech-based. An example of this is when two people 101 and 102 converse using mobile phones, internet voice-chat software, or other media, without seeing each other. There are, however, other exemplary practices wherein the discourse includes not only speech, but also a non-verbal communication modality, such as, for example, and without limitation, speech accompanied by a combination of visual cues associated with posture and/or gesture.

Exemplary prosodic features that may be employed, and examples of what those features may imply in terms of human behavior, by the systems and methods described herein are tabulated in Tables 1A-1I, 2, and 3 below. The tabulated lists are not intended to be comprehensive or limiting in any way. Other prosodic features not listed may be employed by the systems and methods disclosed herein, without departing from the scope hereof.

TABLE 1A
Exemplary Auditive Prosodic Features/Parameters Measured from a
Speech Signal: PITCH-RELATED PROSODIC CUES

Pitch or fundamental frequency F0, Pitch contour (possibly smoothened),
Mean F0, Median F0, Maximum F0, Minimum F0, F0 range, about
95^{th} percentile of F0, about 5^{th} percentile of F0, about 5^{th} to about
95^{th} percentile of the F0 range, Average F0 rise during voiced segment,
Average F0 fall during voiced segment, Average steepness of F0 rise,
Average steepness of F0 fall, Maximum F0 rise during voiced segment,
Maximum F0 fall during voiced segment, Maximum steepness of F0 rise,
Maximum steepness of F0 fall, Normalized segment frequency distribution
width weighted sum, F0 variation, Trend-corrected mean proportional
random F0 perturbation, Amplitudes and bandwidths of the first few
formants (e.g., F1 to about F5)

TABLE 1B
Exemplary Auditive Prosodic Features/Parameters Measured from a
Speech Signal: INTENSITY-BASED FEATURES

Mean RMS intensity, Median RMS intensity, Maximum RMS
intensity, Minimum RMS intensity, Intensity range, about
95^{th} percentile of intensity, about 5^{th} to about
95^{th} percentile range of intensity, Normalized segment
intensity distribution width weighted sum, Intensity variation,
Trend-corrected mean proportional random intensity perturbation.

TABLE 1C
Exemplary Auditive Prosodic Features/Parameters Measured from a
Speech Signal: VOICE/SILENCE-BASED FEATURES

Average duration of voiced segments, Average duration of voiceless/
silent segments shorter than a predetermined amount (e.g., <about
500 ms), Average duration of silences shorter than a predetermined
amount (e.g., <about 400 ms), Average duration of voiceless/silent
segments longer than a predetermined amount (e.g., >about 500 ms),
Average duration of silences longer than a predetermined amount
(e.g., >about 400 ms), Maximum duration of voiced segments,
Maximum duration of voiceless/silent segments, Maximum duration
of silent segments, Voicing/pause ratio, Silence/speech ratio.

TABLE 1D
Exemplary Auditive Prosodic Features/Parameters Measured from a
Speech Signal: ENERGY-BASED FEATURES

Vocal energy, Proportion of energy below a predetermined
frequency (e.g., <about 500 Hz), Proportion of energy
above a predetermined frequency (e.g., >about 1000 Hz).

TABLE 1E
Kinesics (Exemplary Body Movements):
GENERAL BODY MOVEMENTS

Calm, emotionless face, but with active arms, hands, and feet (may imply
tension); strumming or tapping of fingers (may imply nervousness); rapid
arm, hand, and foot activity (tension); tapping and shifting feet
(uneasiness, discomfort); arms folded firm and high across chest (refusal
or defiance); decreased hand movements, often replaced by shrugs
(deception); gross movement of the trunk and shifting of hips (deception).

TABLE 1F
Kinesics (Exemplary Body Movements): GESTURES

Hand-to-mouth gesture, covering mouth when speaking (self-doubt or
deception); gesturing towards self (deception); hand-to-chest gesture
(honesty); gesturing away from body (truthfulness); open palm and open
arms gestures (honesty); reduction in smiling and simple gestures to
illustrate conversational points (tension); rubbing back of neck (deception);
stroking throat area (deception); fidgeting, e.g., looking at watch and
grooming (unwillingness to cooperate); closed body position (awareness
of vulnerability, fear of discovery); non-movement of head with “yes” or
“no” answer (typically, a truthful respondent shakes head up and
down or from side to side when answering “no” and “yes,” respectively;

TABLE 1G
Kinesics (Exemplary Body Movements): MANIPULATORS

Adjust clothing; close or button up coat; tug at pant legs or dress hem;
straighten collar; adjust tie; fidget with top button of blouse or shirt;
attention to clothing stains, dandruff, or lint; make a grooming gesture:
any of these may be an attempt to reduce nervousness, keep hands busy,
allow delay in responding to another agent, and may indicate increased
anxiety or deception.

TABLE 1H
Kinesics (Exemplary Body Movements): HAND-TO-FACE

Stroke the chin; press the lips; rub the cheeks; scratch the eyebrows;
pull the ears; make a hand-to-nose contact; rub nose with index finger;
rub an eye frequently; support chin with thumb and finger held vertically
against the chin: these gestures may indicate a combination of deception,
negation, hostility, doubt, uncertainty, or a negative attitude.

TABLE 1I
Kinesics (Exemplary Body Movements):
MISCELLANEOUS GESTURES

Self-manipulation, e.g., body contact with arms, hands, fingers,
legs, or feet (may indicate deception); holding a handbag or
glasses in two hands (hostility); hand rotations about the wrists
(uncertainty); steepling, i.e., holding fingertips in a steeple fashion
in front of body or face (confidence).

TABLE 2
Exemplary Facial Expressions

| | |
|---|---|
| General Facial | Facial spasms (deception); asymmetry in facial |
| Expressions | expressions (deliberate expression, e.g., deception). |
| Eyes | Increased blink rate, e.g., one per two seconds or 1-2 |
| | per second (deception, stress); eye open wider |
| | than normal (candor); rapid pupil contraction. |
| Smiles | Smile at inappropriate places (suspicion); smirk |
| | instead of smile (deception); smile with upper half of |
| | mouth (disingenuous smile). |
| Lip Movements | Close the mouth tightly; purse the lips; bite the lips |
| | and tongue; lick the lips; chew on objects (anxiety, |
| | tension, deception). |
| Physiological | Perspiration; paleness; flushing; pulse rate increase; |
| Cues | raised neck, head, or throat veins; dry mouth and |
| | tongue; excessive swallowing; respiratory changes; |
| | stuttering (tension and deception). |

TABLE 3
Paralanguage Cues

| | |
|---|---|
| General | Vocal fillers, e.g., um, er, well, uh-uh (stress, |
| | nervousness); high-pitch tone (nervousness, |
| | deception). |
| Special Sounds | Exclamations of surprise; cry; swallow; breakers, |
| | e.g., quivering voice, stuttering (lack of control, |
| | insecurity, deceptiveness). |
| Pace and Quantity | Slower speech rate with increased breakers; |
| | increased hesitation prior to responding, increased |
| | broken and/or repeated phrases, i.e., less fluency: |
| | these may indicate nervousness and/or deception. |

These and other prosodic auditive and visual cues are described in, for example, and without limitation: “The Profiling and Behaviour of a Liar,” by John Boyd, Manager Corruption Prevention, Criminal Justice Commission, Queensland, Australia, presented at SOPAC 2000, Institute for Internal Auditors—Australia, South Pacific, and Asia Conference, 27-29 Mar., 2000; “Silent Messages, “by A. Mehrabian, Wadsworth Pub. Co., 1971; and “Emotion Recognition in Human-Computer Interaction,” IEEE Signal Processing Magazine, Jan. 2001, pp. 32-80.

Prosodic cues such as those listed in Tables 1A-1I, 2, and 3 may be employed by the systems and methods described herein to analyze an exemplary discourse 103 engaged in by the agents 101 and 102 interacting with each other using a videoconferencing system, or using mobile communication devices configured to capture image and/or video data in conjunction with audio information. In yet another illustrative embodiment, the discourse 103 is substantially non-speech-based, such as, for example, when the two agents 101 and 102 converse using a text-based Internet chat software, such as an “instant messaging” application. According to one practice, the agents 101 and 102 use a combination of emoticons, graphical icons, exclamation marks, or various keyboard characters as prosodic signals to express or convey a tone, attitude, or interactive style in their computerized communication; these prosodic cues generally augment and accompany syntactic and semantic content associated with the discourse.

Style includes such parameters as how fast an agent talks, how long the empty spaces are between utterances of the speakers, average length of speech by each speaker, etc. These parameters can be used for assessing a characteristic of the interaction, for example, trust, liveliness, or other characteristics that develop among the participants in the discourse. According to one aspect of this practice, the systems and methods described herein extract prosodic cues associated with the discourse, such as, and without limitation, typing rate, use of iconic visuals expressing a mental state or tone, capitalizations or exclamation marks in the text, pause length between responses, telemetric measurements in general, or biometric measurements in particular, of the agents 101 and 102, and other non-syntactic, non-semantic features of the discourse generally classified as prosodic. Although typically the analysis is performed substantially in real time, this is not necessary. According to one practice, the analysis is performed post hoc, from a record of the discourse. For example, the interaction may be through a set of e-mail exchanges between the agents 101 and 102, saved and archived. Alternatively, the analysis may be performed on an audio, video, or audiovisual recording of the discourse.

Typically, prosody includes features that do not determine what people say, but rather how they say it. Traditionally, the term has referred to verbal prosody, that is, the set of suprasegmental features of speech, such as stress, pitch, contour, juncture, intonation (melody), rhythm, tempo, loudness, voice quality (smooth, coarse, shaky, creaky phonation, grumbly, etc.), utterance rate, turn-taking, silence/pause intervals, and other non-syntactic, non-semantic features that are generally embedded in a speech waveform and typically accompany vowels and consonants in an utterance. Recently, however, the definition has been broadened to include visual prosody, that is, specific forms of body language that interacting agents employ to communicate with one another during their discourse; examples of visual prosody include, without limitation, facial expressions such as smiling, eyebrow movement, blinking rate, eye movement, nodding or other affirmative or dismissive head movements, limb and other bodily gestures, such as strumming or tapping a finger, folding of arms, shrugging, tapping of feet, adjusting clothing, fidgeting, and various other forms of communication generally classified as kinesics and proxemics, etc., at least partially listed in Tables 1A-1I, 2, and 3. Herein, prosody is used in its broader scope, and includes a combination of verbal (more generally, auditive) and visual features.

In one embodiment, the discourse may be substantially visual, and may have insubstantial speech or other auditive content. Instant messaging between two interacting humans who do not see each other is an example of this embodiment.

FIG. 1 depicts the two agents 101 and 102 engaged in a discourse 103. Prosodic information associated with the two agents 101 and 102, as well as the discourse 103 in general, is collected using at least one of the data signals 121-123, respectively. In one embodiment, the data signal 123 may form a substantial amount of the collected data, containing a mixture of data from the agents 101 and 102; in other words, agent-specific data may not be available in separated forms 121 and 122, in this embodiment. According to various practices, the data signals 121-123 are produced from a combination of monitoring devices such as biometric instrumentation, cameras, microphones, keyboards, computer mice, touchpads, or other sensing devices which can be located in proximity of the agents 101 and 102 to collect data. Even a sensor, such as a microphone, which is uniquely associated with one of the agents, typically senses the voice of the other agent, for example, when the two agents are proximate to each other and engaged in a face-to-face conversation.

If the discourse 103 includes speech, as it would in a typical embodiment, then a speaker separation (otherwise known as a source separation) method may be applied to the data signal 123 to distinguish information associated with the speaker/agent 101 from data associated with the speaker/agent 102. For example, independent component analysis, principal component analysis, periodic component analysis, or other source separation methods may be used to separate data associated with the agents 101 and 102. According to one practice, a hidden Markov model (HMM) may be employed to separate speech waveforms associated with various speakers (and optionally from ambient sounds) using a low-frequency energy-based scheme (T. Choudhury and A. Pentland, “Modeling Face-to-Face Communication Using the Sociometer”, Proceedings of the International Conference on Ubiquitous Computing, Seattle, Wash., October 2003).

In one practice, a subset of the data signals 121-123 may include noise, and one or more noise-removal methods may be used to separate, or filter, the noise to substantially suppress it or to otherwise alter its form. Signal source separation used by certain embodiments of the systems and methods described herein follow principles described in the following exemplary reference, among others: “Unsupervised Adaptive Filtering, Volume 1: Blind Source Separation”, by Simon Haykin (Ed.), Wiley-lnterscience, 2000, ISBN 0471294128.

The data signals 121-123, which generally contain a combination of auditive and visual data, may be obtained using a variety of methods. For example, auditive data may be obtained using microphones present near one or both of the agents 101 and 102.

The information collected from a combination of the data signals 121-123 is fed to an input processor 130 associated with a computer system 150. According to one practice, the computer system 150 includes various components: the input processor 130, the output interfaces 140a and 140b, the memory 160, the CPU 170, and the support circuitry 180. The CPU 170 serves as the data processing engine implementing the methods according to the invention; the support circuitry 180 provides various services to the computer system, such as supplying and regulating power to the computer 150; and the memory 160 provides data storage for the computer 150, and typically includes both persistent and volatile memory. The memory 160 includes software configured to execute on the computer 150 to implement the methods of the invention, such as, for example, the prosodic feature extraction algorithms 162 and the flow of interaction analysis algorithms 164. Other software applications that may be needed or desirable in a particular embodiment are not shown in the figure, but it is understood that the computer memory 160 contains such software accordingly. The various links 163, 165, 167(a-b), 169, 182, and 184 denote communications that can occur between the various respective components of the computer system 150. For example, the link 163 shows an optional connection between the input processor 163 and the memory 160, enabling the processor and the memory to exchange information. The embodiment depicted by FIG. 1 includes an optional feedback mechanism shown by the feedback arrows 131 and 132. The embodiment optionally provides to a subset of the agents (the agent 101, the agent 102, or both) feedback about the discourse, where the discourse is at, where it is going, how it can be altered, etc.

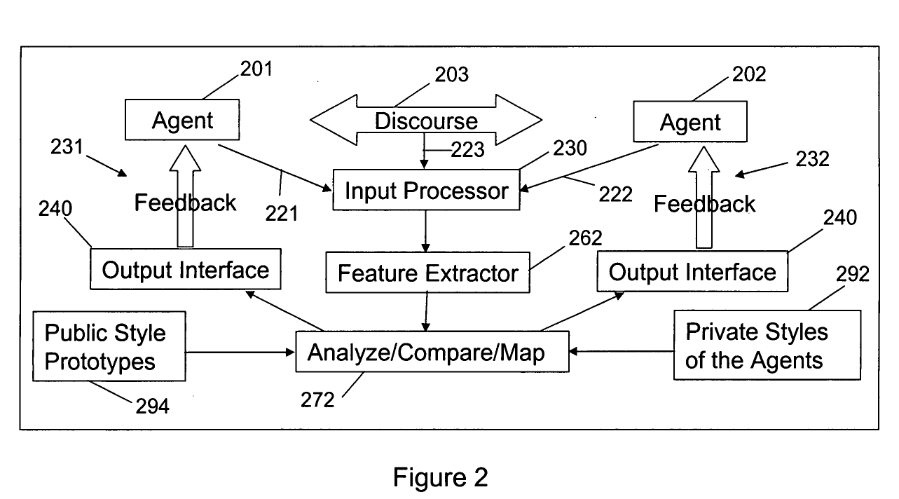

FIG. 2 illustrates in greater detail the nature of the feedback process, which gives information on the style and tone of the interaction in both a detailed mode and in a mapped mode to one or both of the agents 201 and 202. In the detailed mode, the feedback 231, 232, or both, includes details of the prosodic information associated with the discourse 203. Examples of these features are, as stated earlier, pitch, energy, speaking rate, changes from a speaker's norm, and others. In the mapped mode, the information is combined with stored information, which is unique to the individual and/or to the other individuals in the conversation and/or with individuals who are not in the conversation, but who somehow are considered representative of the agents 201 and 202. These representative agents include potentially iconic/prototypical figures (eigenfigures or eigenagents) whose behaviors provide a normed reference or benchmark (eigenbehaviors or eigendiscourse) for use in comparisons.

An embodiment according to FIG. 2 includes processing, using the input processor 230, a subset of the data signals 221-223 collected, using sensors for example, from the agents and their discourse. The input processor 230 then produces the data in a form from which the prosodic features of the collected data can be extracted. This is the task of the feature extractor 262, which typically includes a software algorithm running on the computer system 150 of FIG. 1. The extracted prosodic features can then be processed, individually or collectively, by reference to either or both of the public style prototypes archive 294 and the private style archive 292. The private styles archive 292 includes an archived record of a past behavior of a subset of the agents 201 and 202. The record may correspond to one or more previous discourses engaged in by the agents 201 and 202, not necessarily with each other. For example, if an individual record of a previous behavior of the agent 201 is available in the private archive 292, the behavior of the agent 201 in the discourse 203 can be compared with the agent's previous behavior, and feedback 231 may be rendered to the agent 201 accordingly.

Alternatively, or additionally, the behavior of the agents 201 and 202 in the current discourse may be compared with a public archive of behaviors of representative agents. For example, the archive 294, according to one embodiment, includes information about other agents who have engaged in a similar discourse (where by similar discourse it is meant that the discourse is conducted under a similar context, perhaps having a similar outcome, e.g., closing a sale). In this embodiment, prosodic features associated with the archived discourses 294 are available. According to one practice, the prosodic features extracted by the feature extractor 262 from the discourse 203 are analyzed, compared with, and/or mapped 272 to the archived features in 294. Accordingly, the feedback 231 and/or 232 is rendered to the respective agents 201 and 202, via the output interface 240 of the computer system 150 (not shown in FIG. 2), based on a mapping to information stored in a combination of the archives 292 and 294. Alternatively, or additionally, as stated earlier, the feedback 231-232 may include details of the prosodic features extracted 262 from the discourse 203; this is a detailed-mode operation of the systems and methods described herein.

In one practice, information stored in the archives 292 and/or 294 may be used by the systems and methods of the invention to predict a future behavior of one or more of the agents 201 and 202, and/or a future state (such as a future characteristic) of the discourse 203. In one exemplary aspect, a vector of prosodic cues is measured from the discourse 203 and compared against statistical information stored in one or both of the archives 292 and 294. According to the statistical information, the likelihood of a future characteristic of the discourse and/or a future action of one or more of the agents 201 and 202 is assessed.

For example, statistical information may indicate that given the current measured vector of prosodic cues, the likelihood of a shouting match ensuing is high; therefore, one or both of the agents 201 and 202 may be given feedback suggesting to them to lower their voices or to modify another set of one or more prosodic features to steer the discourse away from the predicted shouting match. Alternatively, or additionally, the systems and methods disclosed herein may force a set of one or more constraints on the discourse in anticipation of the predicted state; for example, if the discourse 203 includes a telephone conversation between the agents 201 and 202, the systems and methods described herein may—in anticipation of a shouting match ensuing—lower the volume of one or both speakers (possibly even without their consent), thereby potentially preventing a breakdown in the discourse (an undesirable outcome).

According to another exemplary aspect, a state vector including, for example, the vector of prosodic cues, is constructed and measured at predetermined time instants of the discourse. A Kalman filter is then used to process past and current information, based on a mathematical (such as a Bayesian) model of the discourse to predict a subsequent state. Recursive filters other than the Kalman filter may be used in estimating the vector of prosodic cues. Alternatively, the prosodic features may be divided into various subsets, each subset being estimated by a method specifically tailored or otherwise suitable for that subset. For example, one subset of the prosodic cues may be processed using a Kalman filter, and another subset may be processed using another type of filter, or even a nonlinear filter. In any event, based on the predicted discourse state or characteristic (including, for example, agent behavior), the systems and methods described herein can render feedback 231-232 to a subset of the agents.

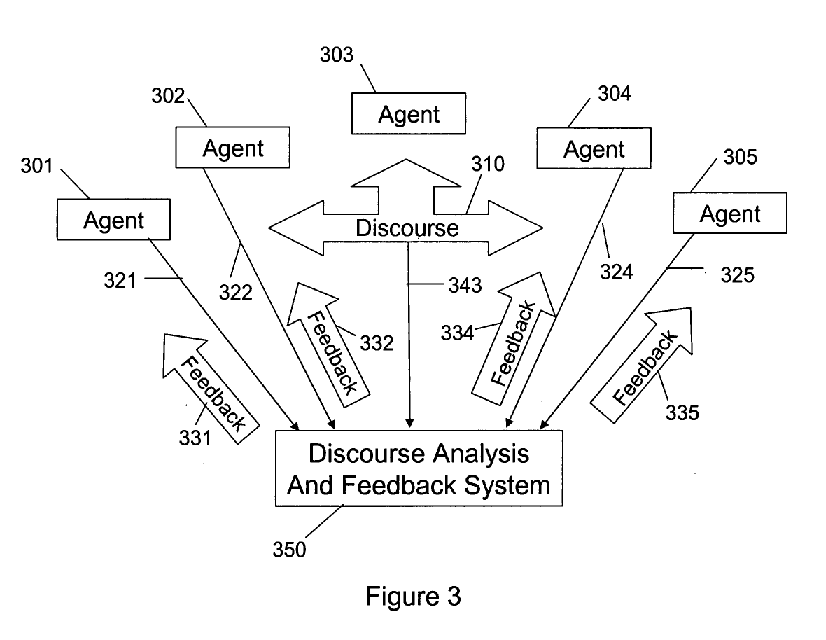

FIG. 3 illustrates an embodiment wherein multiple participants 301-305 engage in a discourse 310; the discourse may be analyzed in real time or on a post-hoc basis. This type of interaction 310 is typical of recent online social networking applications that are popular on the Internet. In an embodiment according to FIG. 3, the optional data signals 321-322 and 324-325 are obtained from respective agents 301-302 and 304-305. The data signal 343 represents collected data that is somehow not agent specific; for example, the data signal may include a mixture of data (auditive, visual, etc.) from the agents, data that may have to be separated (e.g., ambient or other type of noise), or it may include global, collective interactive features of the discourse 310. Examples of global characteristics of a discourse include, but are not limited to, footing and alignment, inter-related concepts known in the art of discourse analysis, and described in, for example and without limitation, “Forms of Talk” by Erving Goffman, Oxford: Blackwell, 1981. In one aspect, footing is a function of a discourse participant's shifting alignments in response to circumstances and events governing or influencing the discourse. Footing is typically, though not necessarily, a discursive mechanism, and may include, for instance, participation status. In another aspect, footing refers to interactional stances of the discourse participants in relation to one another, influenced at least in part by their changing roles, positions, or alignments. Typically, footing is relational and changing, as participants' roles change vis-à-vis one another. Global characteristics may be contrasted with specific characteristics of the discourse, such as, without limitation, a deictic center of a speaking participant, a reference in relation to which a deictic expression is made by the participant.

According to various aspects, at least one of the data signals 321-322, 324-325, and 343 may be available, not necessarily all of them. Moreover, the availability of the data signals may be time dependent; for example, whereas a data signal may be available for a particular first time interval, it may not be for at least a portion of a second time interval distinct from the first time interval. This can happen, for example, if the number of the agents changes during the discourse, wherein one or more new agents enter the discourse and one or more agents leave (this is typical of an Internet chat room setting). According to one embodiment, the first and second time intervals do not overlap; one of the two intervals is in the future, relative to the other. In another embodiment, the first and second time intervals at least partially overlap, but remain distinct based on having distinct temporal boundaries; in this embodiment, at least a portion of one of the two intervals is in the future and/or in the past relative to at least a portion of the other time interval.

According to one embodiment, the discourse of FIG. 3 includes a multilateral/multi-agent negotiation over a set of one or more issues. The subject of the dynamics of multi-agent negotiations is of interest in a variety of contexts (see, for example, F. van Merode et al., “Analyzing the dynamics in multilateral negotiations”, Social Networks, 26 (2004), pp. 141-154, where the authors study the dynamics of negotiations over pricing of medical care in the Netherlands). A negotiation-based discourse typically includes at least two phases: a negotiating phase and a decision-making phase, each phase having a distinctive set of associated characteristics. For example, the agents typically behave differently in the various phases. Usually, a primary goal of an agent during the negotiating phase is to influence other, competing agents; the goal then shifts to reaching a settlement in the decision-making phase. This is highlighted in a discourse scenario wherein a threat of an independent, outside intervention looms. For example, a negotiation between striking union workers and a company may be subject to a court-designated settlement deadline guided by a court-appointed mediator; faced with a looming intervention, the agents representing the negotiating parties may have to shift to a discourse phase wherein a desirable outcome is to reach a settlement through cooperation, and not so much to influence a policy position of the other competing agents through competition or confrontation (which is typically the case in a prior phase of the discourse).

As mentioned above, even the number or make-up of the agents may change during a discourse. While some agents may partake in a negotiation for purely administrative and/or formal reasons, other agents may engage in the negotiation as leading advocates of their points of view, and as such may deliberately and/or competitively seek to influence other agents representing alternative bargaining positions.

A desirable outcome in one phase of the discourse is not necessarily as desirable (or even desirable at all) in another phase. Agents may also participate in the discourse for the full duration of the discourse, or they may participate temporarily or intermittently.

Behavioral dynamics of agents in a dyadic discourse (a discourse involving primarily two competing interests) are typically distinct from the behavioral dynamics of agents in a multilateral discourse where multiple competing interests are at play; for example, it has been observed that it is easier to convince or otherwise desirably influence other, competing agents when the there is primarily one competing bargaining position, than it is to convince other agents in a multilateral setting where there are generally multiple competing, and possibly even conflicting, interests.

According to various embodiments, the systems and methods described herein are directed at accounting for various phases of the discourse, their corresponding desirable outcomes, and the behavioral dynamics of the agents during those phases. Accordingly, when the agents 301-305 represent multiple competing positions/interests in the multilateral, perhaps negotiation-based, discourse 310, the systems and methods described herein adjust a subset of the feedbacks 331-332, 334-335, and 343 to at least account for the phase of the discourse at a time when feedback is rendered. The adjustment is based at least partially on a dynamic database of public and private style prototypes (not shown in FIG. 3, but shown in FIG. 2) containing information about normative, that is, prototypical, behavioral dynamics for the discourse phase of interest.

To avoid clutter in FIG. 3, neither a data signal nor a feedback path is shown associated with the agent 303; however, it is understood that either or both a data signal and feedback may be associated with the agent 303 in certain embodiments. Depicted by FIG. 3 are feedback paths associated with the systems and methods described herein. Feedback paths 331-332 and 334-335 are shown associated with the respective agents 301-302 and 304-305. As stated earlier, the feedback paths are optional, and a subset (including an empty subset) of the agents 301-305 may receive feedback, in an embodiment of the invention. Moreover, the feedback modalities/types can be varied, as previously described. Similarly, as described with respect to the previous figures, the data signals may include a combination of auditive, visual, biometric, and other data collected using a combination of various sensors associated with the agents and/or the discourse.

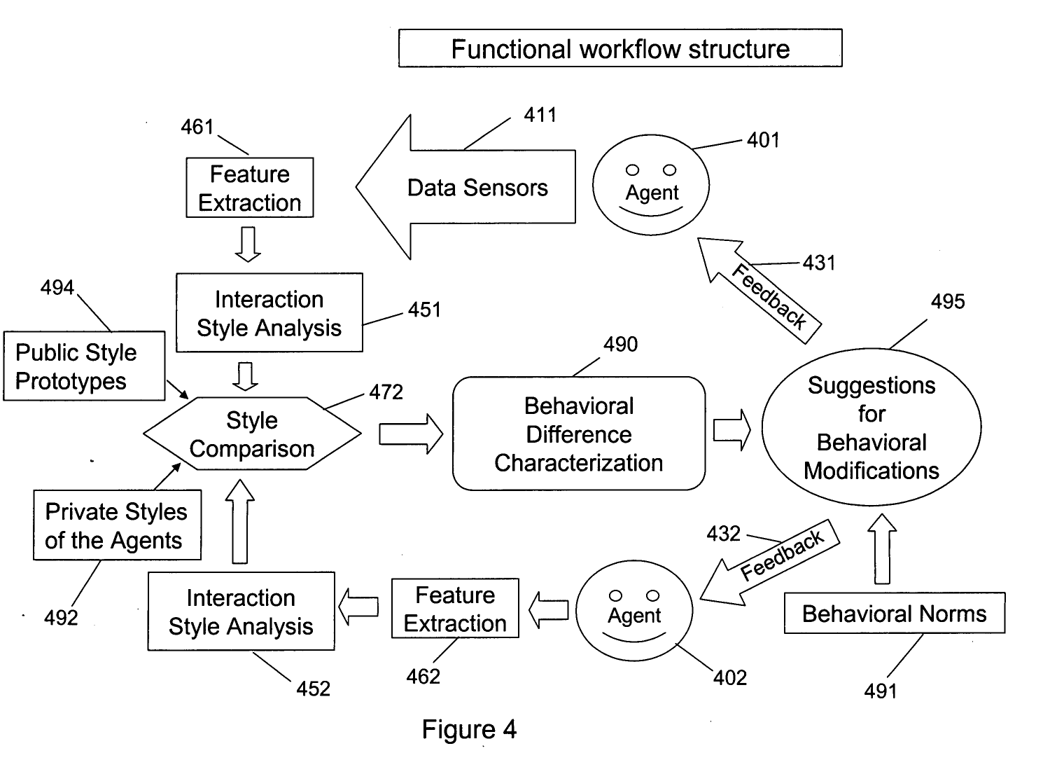

FIG. 4 illustrates, in greater detail, an exemplary embodiment of the functional workflow structure of a discourse analysis function according to the invention. The discourse (not shown) of FIG. 4 involves the two agents 401 and 402. Using one or more sensors 411, prosodic data is obtained from the agent 401. A data sensor may include a combination of a mobile phone, a personal digital assistant (PDA), a microphone, or any of the sensors listed in relation to the previous figures. To avoid clutter, data sensors associated with the agent 402 are not shown in FIG. 4; however, it is understood that such sensors are employed in certain embodiments to collect data from the agent 402. In any event, feature extractors 461-462, respectively associated with the agents 401-402, extract prosodic features associated with the agents. Respective interaction style analyses 451-452 are performed on the extracted prosodic features. The interactive styles assessed by the style analysis stages 451-452 are then studied by a comparator 472. In one embodiment, the comparator 472 compares the interactive styles, respectively assessed by the style analyzers 451-452, with each other. In one embodiment, the comparator 472 compares the interactive styles, respectively assessed by the style analyzers 451-452, with a combination of the two style archives 492 and 494 associated, respectively, with the private style prototypes of the agents 401-402 and public style prototypes of representative agents (eigenagents).

The interaction style comparator 472 produces a characterization 490 of a behavioral difference; in one embodiment, the characterization 490 of the comparisons shows higher level stylistic patterns suggesting particular modifications, such as slowing down, speeding up, reducing volume, changing intonations and/or body language, etc., which can lead, for example, to better trust and synchrony between the agents 401 and 402. Alternatively, the modifications may be recommended at least in part because in similar situations they have frequently resulted in a desired outcome. The behavioral difference 490 may include a difference between the behaviors of the agents 401 and 402. Alternatively, or additionally, the behavioral difference 490 may include a difference between a style mapping associated with the agent 401 and a style mapping associated with the agent 402, possibly indicating that the agents have incompatible styles or complementary styles. In any event, the characterized behavioral difference 490 is then used to produce a set of one or more behavioral modification suggestions 495 to be conveyed via one or both of the feedback paths 431 and 432 to the respective agents 401 and 402.

In a typical embodiment, the suggested behavioral modifications take into account the context of the discourse and acceptable behavioral norms 491, or norms of behavior that are calibrated according to, or that are otherwise applicable to, the context of the discourse between the agents 401 and 402. After all, a behavioral modification suggestion that may be appropriate in the context of a sales transaction may not be appropriate in the context of a police-suspect interrogation, for example.

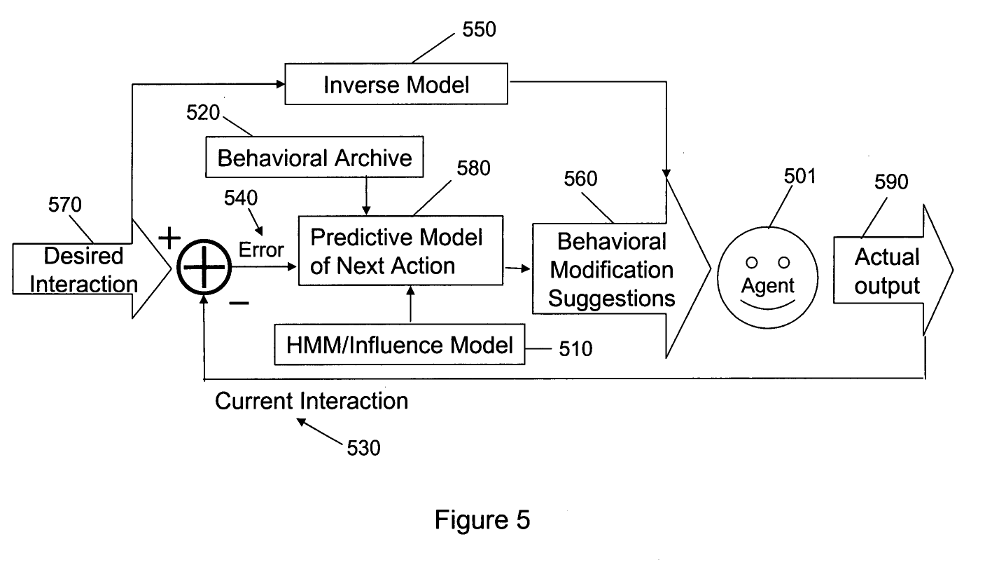

FIG. 5 shows a general feedback-error learning model according to an embodiment of the invention, in the context of an interactive style improvement application. According to one practice, a comparison is made between features associated with a desired interaction 570 and the actual output 590, which at least partially determines the current interactive style 530; the current interactive style 530 may also include information associated with the global characteristics of the discourse (not shown) or specific characteristics associated with one or more other agents (not shown) engaged in the discourse.

The error term 540 is produced by taking a difference of the desired interaction 570 and the interaction 530 being analyzed. The difference may be associated with a state of the desired interaction 570 and a state of the interaction 530 being analyzed. Alternatively, the difference may be associated with a set or vector of measurable features characteristic of the desired interaction 570 and a corresponding set or vector associated with the subject interaction 530. Based at least in part on the error 540, a next action, state, or characteristic of the interaction or behavior of the agent 501 is predicted by the model 580. The prediction model 580 may optionally employ a behavioral archive 520 (containing a combination of public norms and private styles of behavior, as described in relation to the previous figures) to predict the next action in the current discourse.

Alternatively, or additionally, the predictive model 580 may base its output at least in part on a hidden Markov model and/or influence model representation 510 of the discourse and/or a subset of the interacting agents. For example, by knowing the influence that the agent 501 has on another agent, and vice versa, the predictive model may at least partially predict a next state or action by the agent 501, or by the other agent in the discourse. In one practice, the influence of the agent 501 on another set of one or more agents (not shown in FIG. 5) is inferred from a centrality measure associated with the agent 501 in a graph representation of the network of the interacting agents.

A variety of measures of centrality, for example, those known widely in the social network theory, may be used by the systems and methods described herein, depending on the context. According to one embodiment, centrality includes betweenness centrality, which measures how much control an individual/node/agent in a social network has over the interaction of other individuals belonging to the network who are not directly connected to each other. In one aspect, betweenness centrality captures the role of “brokers” or “bridges” in a network, those possessed of large indirect ties and capable of connecting or disconnecting portions of the network.

According to one embodiment, closeness centrality—which, on a graph representation of a social network, is the sum of geodesic distances of an agent (i.e., node) to all other agents (nodes) belonging to the network—is used. In an alternative embodiment, eigenvector centrality—which is a measure of walks of all lengths, weighted inversely by length, emanating from a node in a mathematical graph representing a network of interacting agents—is used. In one embodiment, degree centrality is used; this measure of centrality is associated with the total number (or weight) of ties that an agent (or node in a network) has with all other agents. In one practice, expansiveness and/or popularity of an agent may be inferred from the agent's degree centrality. An agent with a relatively large degree centrality is typically considered to be a connector or a hub. In some embodiments, one or more variants of these measures of centrality may be used, for example, relative degree centrality (ratio of the degree of an agent over the highest degree of any agent in the network), relative betweenness centrality, and relative closeness centrality.

In addition to, or instead of, one or more agent-based measures of centrality, the systems and methods described herein may use one or more network-wide measures of centrality, for example, network degree centralization, network closeness centralization, network betweenness centralization, etc. A network centrality measure is considered useful in assessing a characteristic of a network of interacting agents, because, loosely speaking, the larger the centrality measure of a network, the higher the network's cohesion, and, generally, the higher the likelihood of having the agents belonging to the network reaching a common goal. A more cohesive network also typically results in better network-wide control and/or influence over its individual member agents.

In one embodiment, the graph representation is a directed graph, with a directed arc pointing away from a node representing the agent 501 denoting an influence or control that the agent 501 has on another agent to whom (or to which) the arc points. An out-degree measure associated with the node representing the agent 501 may be indicative of the power, prestige, control, respect, or other analogous hallmark of influence that the agent 501 wields with respect to the other agents engaged in the discourse. If the node associated with the agent 501 has a relatively high out-degree, then a degree centrality of the agent 501 is high, thereby indicating that the agent wields considerable influence. Accordingly, a future state or characteristic of the discourse is determined by taking into account the degree centrality of the agent 501.

A directed arc pointing into the node representing the agent 501 may denote support that the agent receives from another node representative of another agent from whom (or from which) the arc originates. Alternatively, a directed arc pointing into the node representing the agent 501 may be indicative of a level of influence, power, control that the agent 501 is under, with respect to another agent from the representative node of whom (or which) the arc emanates. In one exemplary embodiment, an in-degree measure of the agent 501 indicates support, such as by voters, in the discourse. In another embodiment, it may indicate the subservience of the agent, if the in-degree is indicative of the influence that another agent has on the agent 501.

In another aspect, the systems and methods described herein employ the influence model of Asavathiratham, as described in, for example, “Learning Communities: Connectivity and Dynamics of Interacting Agents,” by T. Choudhury et al., MIT Media Lab Technical Report TR#560, which also appeared in the Proceedings of the International Joint Conference on Neural Networks—Special Session on Autonomous Mental Development, 20-24 Jul. 2003, Doubletree Hotel, Jantzen Beach, Portland Oregon—Special Session W3S: Autonomous Mental Development, Wednesday, July 23, 2:40 PM , “Learning Communities: Connectivity and dynamics of interacting agents” [#854], Tanzeem Choudhury, Brian Clarkson, Sumit Basu, and Alex Pentland, MIT.

According to various embodiments, the actual output 590, the current interaction 530, the desired interaction 570, and the error 540 may include a vector representation of prosodic features associated with the discourse. According to one practice, the error 540 includes a Euclidean difference between the vector representative of the subject interaction 530 being analyzed and the vector representing the desired interaction 570. Alternatively, a Euclidean distance between the current interaction vector 530 and the desired interaction 570 may be used to characterize the error 540.

The inverse model 550 typically includes a mapping between a set of parameters characteristic of the desired interaction 570 and the set of behaviors that bring about the desired interaction. For example, the inverse model may map the desired outcome of enabling a 911 operator (agent 501) to assist a frantic caller (not shown) to a certain voice volume/rate profile; that is, if the operator 501 has a voice volume within a prescribed range and/or speaking rate within a prescribed range, then a desired interaction 570 is likely to ensue. The inverse model 550, then, is used by the systems and methods described herein to impact the behavioral modification suggestions 560 formulated to provide feedback to the agent 501. Based on the predicted state/action/characteristic and on the output of the inverse model 550, one or more behavioral modification suggestions 560 are conveyed to the agent 501, aimed at bringing the current interaction 530 closer to the desired interaction 570.

Optionally, the model shown in FIG. 5 may include a noise term (not shown) contributing to the error 540. According to one embodiment, the noise term contributes additively to the error term 540; according to another embodiment, the noise term contributes multiplicatively to the error term 540. In one practice, the noise term includes Gaussian noise.

In one embodiment wherein the current interaction 530, the error 540, and the desired interaction 570 are Euclidean vectors of prosodic features, the predictive model 580 includes a Kalman filter that predicts a next state of the discourse based on the current and past states of the discourse, using, for example and without limitation, Bayesian information and optimization criteria. Therefore, if the discourse is divided into feedback iteration cycles, the Kalman filter uses the current state of the discourse and the past states (at previous feedback cycles), to predict the state at the next cycle.

The systems and methods described herein employ, in various embodiments, principles of recursive filtering, including Kalman filtering, to predict future states of a time-evolutionary process, such as an evolving discourse engaged in by a plurality of interacting agents. Recursive filtering principles include those described by the following exemplary references: “Fundamentals of Adaptive Filtering”, by Ali H. Sayed, John Wiley and Sons, 2003, ISBN 0471461261; “Kalman Filtering and Neural Networks”, by Simon Haykin, Wiley-lnterscience, 2001, ISBN 0471369985; “Linear Estimation”, by Thomas Kailath et al., Prentice-Hall, 2000, ISBN 0130224642; and “Adaptive Filter Theory, 4^{th} Edition”, by Simon Haykin, Prentice-Hall, 2001, ISBN 0130901261.

As mentioned earlier, the inverse model 550 that produces one or more output controls to effect a change in the interaction is substantially a functional mapping taking prosodic features as inputs and producing behavioral actions (including, but not limited to, prosodic modifications) as outputs. Various models can be used to characterize the inverse model 550. For example, and without limitation, stochastic Bayesian network models that employ asymptotic approximations, maximum likelihood estimation (MLE), including, for example, an expectation-maximization (EM) implementation of the MLE, or algorithms that use neural networks and/or radial basis function networks to model the stylistic variables of interest to the systems and methods described herein may be used in various embodiments.

In certain embodiments, approaching the desired interaction involves simultaneous optimization of multiple objectives. Using single-objective optimization procedures, arriving at a solution (whereby a target, desired interaction is specified) may be difficult. For such embodiments, evolutionary algorithms may be employed to find a Pareto-optimal set of features characterizing a desired interaction. In particular, a genetic algorithm may be used to iteratively home in on a Pareto-optimal boundary descriptive of the desired interaction. Accordingly, one or more of the agents engaged in the discourse are given instructions or suggestions on how to modify their respective behaviors to drive the discourse to a point on the Pareto-optimal boundary of solutions. Methods of evolutionary algorithms in general, and genetic algorithms in particular, are described in “Multi-Objective Optimization Using Evolutionary Algorithms,” by Kalyanmoy Deb, John Wiley & Sons, 2001, ISBN: 047187339X.

According to one embodiment, the flow of the methods and systems described herein is as follows. As a first step, determine whether the systems and methods described herein will be initially customized by training based on individual agents or sets of agents within a particular context (e.g., conversing Japanese school girls). Next, determine whether the systems and methods described herein rely on global human-communications protocols.

When initializing the systems and methods described herein, using as an optional input to the system a set of desired outcome parameters (e.g., time to obtain x % compatibility among persons A, B, and C; degree of turn taking, dominance, % air time, % shakiness of voice, % synchrony, speed of speaking and/or non-verbal gesturing, etc.) is specified by one or more agents or by another party. The system is then trained to develop prototype patterns for the individual and/or an ideal utopian pattern of interaction, wherein ideal is context dependent, for example, business or pleasure.

As a next, optional, step, post-training information is gathered from a set of two or more agents to find matches among those who are compatible in accordance with a specified compatibility algorithm. For example, agents may be sought to engage in a discourse, based on archived normative behaviors of eigenagents, and their corresponding behavioral prosodic features. Data from a new set of agents may be collected and compared with the archived data, to determine which subset of the new agents most closely, or sufficiently closely, meets a compatibility measure.

A subsequent step of an embodiment of the systems and methods described herein includes providing feedback to a subset of the agents to allow them the opportunity to modify their behavior. The feedback may optionally include providing to the subset of the agents updated information about the interactions (such as measured prosodic cues). The interacting agents may use the feedback to effect changes in their behaviors.

As a next step, an embodiment of the systems and methods described herein includes calculating the various agents' inputs and determining clusters of behaviors that maximize the likelihood of a desired outcome. At prescribed intervals, the systems and methods described herein optionally update the global normative behavior archives and/or the agent-specific behavioral archives, for future use.

Data classification and pattern analysis techniques, used by various embodiments of the systems and methods described herein, follow principles laid out in the following exemplary reference, among others: “Pattern Classification: 2^{nd} Edition”, Richard O. Duda et al., Wiley-lnterscience, 2000, ISBN 0471056693. Collective/public behavioral prototypes or individual agent-specific behavioral prototypes that are used by the systems and methods described herein as archived databases for matching/mapping a current interaction to normative interactions, can be constructed using principles known in data classification, pattern analysis, and estimation theory.

One method of constructing an archive of normed (prototypical) collective behavior, for example, is to select prosodic features of interest and measure those features for a number of groups of agents in similar interactive contexts. Multivariate probability density or mass functions can be constructed based on the data, using, for example, multivariate histograms of historical measurements of the prosodic cues in similar contexts. Other methods may be employed to construct probabilistic models of the prosodic features associated with various types, states, or characteristics of discourses. Models of behavioral dynamics may be used to construct statistical models of agent behavior.

As mentioned above, one way of looking at the prosodic features is by constructing a vector of measured prosodic cues. A multivariate probability density (or mass) function may then be constructed based on measurements of the prosodic cues vector. The probabilistic model may be updated as new measurements of the prosodic cues are made.

Alternatively, or additionally, if a known probability density function is considered to model the normative behavioral data reasonably well, a combination of one or more estimation techniques may be used to determine the parameters specifying the particular form of the probability density function. For example, if in a particular embodiment, a multivariate Gaussian density function is considered to be a reasonable model of the normative behaviors of the eigenagents in a particular context, then the parameters (such as the mean vector and covariance matrix) associated with the multivariate Gaussian density function may be estimated from the collected data using known statistical techniques. Once new measurements are made from the subject discourse being analyzed, methods such as maximum likelihood may be used to estimate a state and/or characteristic of the discourse.

The contents of all references, patents, and published patent applications cited throughout this specification are hereby incorporated by reference in entirety.

Many equivalents to the specific embodiments of the invention and the specific methods and practices associated with the systems and methods described herein exist. Accordingly, the invention is not to be limited to the embodiments, methods, and practices disclosed herein, but is to be understood from the following claims, which are to be interpreted as broadly as allowed under the law.

1. A computerized method of analyzing a discourse engaged in by a plurality of interacting agents, comprising:
a. during a first time interval, measuring a first set of prosodic features associated with the discourse; and
b. at least partially based on the first set, determining a target set of prosodic features, wherein the target set is likelier to be associated with a target state of the discourse than the first set.

2. The method of claim 1, including suggesting to a subset of the agents a behavior for increasing a likelihood of producing the target state.

3. The method of claim 2, wherein the suggesting includes at least one of recommending content, emphasizing a subject for the discourse, interacting according to a particular style, level and nature of detail.

4. The method of claim 2, wherein the behavior includes a prosodic behavior.

5. The method of claim 4, including determining a difference between the suggested prosodic behavior and a prosodic behavior implemented at least partially in response to the suggested prosodic behavior by the subset of the agents.

6. The method of claim 5, including suggesting to the subset of the agents, and based at least partially on the difference between the suggested prosodic behavior and the prosodic behavior implemented by the subset of the agents, a modification to the implemented behavior for increasing the likelihood of producing the target state.

7. The method of claim 1, including predicting a state of the discourse based at least partially on the first set of prosodic features.

8. The method of claim 7, including, based at least partially on the predicted state, suggesting to a subset of the agents a prosodic behavior for increasing a likelihood of producing the target state.

9. The method of claim 1, including applying a stimulus to a subset of the agents for modifying a prosodic behavior of the subset of the agents, to at least approximately produce a subset of the target set of prosodic features, thereby increasing the likelihood of producing the target state.

10. The method of claim 9, including predicting a reaction of the subset of the agents to the stimulus.

11. The method of claim 9, wherein applying the stimulus includes conveying feedback to a subset of the agents.

12. The method of claim 11, wherein the feedback includes information associated with a combination of a subset of the first set of prosodic features, a subset of the target set of prosodic features, a difference between the first set of prosodic features and the target set of prosodic features, a prosodic modification sufficient for producing the target state, a prosodic modification necessary for producing the target state, and a prosodic modification for increasing a likelihood of producing the target state.

13. The method of claim 11, wherein the feedback includes a subset of auditive feedback, visual feedback, tactile feedback, olfactory feedback, gustatory feedback, synthetically-generated feedback, mechanical feedback, physical feedback, and electrical feedback.

14. The method of claim 1, including imposing, at least partially in response to the first set of prosodic features, a constraint on the discourse to at least approximately produce the target set of prosodic features, thereby increasing the likelihood of producing the target state.

15. The method of claim 14, wherein imposing the constraint includes changing an environmental characteristic associated with the discourse.

16. The method of claim 1, including determining from the first set of prosodic features at least one characteristic of the discourse associated with a combination of an emotional state, attitude, a physical state, truthfulness, cooperation, deference, affection, compatibility, trust, interactive dominance, a measure of success, a measure of failure, enthusiasm, interest, influence, agreement, respect, empathy, compliance, and a mental state.

17. The method of claim 1, including measuring, during at least one other time interval, at least one other set of prosodic features associated with the discourse.

18. The method of claim 17, including determining, based on the first set of prosodic features and the at least one other set of prosodic features, a trend in at least one characteristic of the discourse.

19. The method of claim 17, including updating, based on the first set of prosodic features and the at least one other set of prosodic features, an estimate of a prosodic behavior associated with a subset of the agents.

20. The method of claim 1, including compiling information associated with a correlation between the target state and a benchmark prosodic feature.

21. The method of claim 20, wherein the correlation includes a statistical correlation.

22. The method of claim 21, wherein the compiled information includes information about a likelihood that the benchmark prosodic feature produces the target state.

23. The method of claim 1, including determining at least one set of intermediate prosodic features likelier to be associated with the target state than the first set, but at most as likely to be associated with the target state as the target set.

24. The method of claim 1, wherein a subset of at least one of the first set of prosodic features and the target set of prosodic features includes an auditive prosodic feature.

25. The method of claim 24, wherein the auditive prosodic feature includes a discourse characteristic associated with a combination of turn-taking, interruptions, percent airtime, voice shakiness, mutual prosodic harmony, voice pitch, voice energy, voice volume, speaking rate, voiced speech statistics, unvoiced speech statistics, response time, accent, speech intonations, voice fundamental frequency, voice phonemes, vocal stress, voice nasalization, suprasegmental voice features, and subsegmental voice features.

26. The method of claim 1, wherein a subset of at least one of the first set of prosodic features and the target set of prosodic features includes a visual prosodic feature.

27. The method of claim 26, wherein the visual prosodic feature includes a discourse characteristic associated with a combination of a facial expression, a head movement, a gaze, a body gesture, and a posture.

28. The method of claim 1, wherein a subset of at least one of the first set of prosodic features and the target set of prosodic features includes an audiovisual prosodic feature.

29. The method of claim 1, wherein the target state is determined at least partially based on a desirable outcome for the discourse.

30. The method of claim 1, wherein the target state is determined at least partially based on an undesirable outcome for the discourse.

31. A computerized method of analyzing a discourse engaged in by a plurality of interacting agents, comprising:
a. during a first time interval, measuring a first set of prosodic features associated with the discourse; and
b. at least partially based on the first set, suggesting to a subset of the agents a behavior for increasing a likelihood of producing a target state of the discourse.

32. The method of claim 31, wherein the suggesting includes at least one of recommending content, emphasizing a subject, interacting according to a particular style, level and nature of detail.

33. The method of claim 31, wherein the behavior includes a prosodic behavior.

34. The method of claim 33, wherein the prosodic behavior causes a change in a subset of the prosodic features.

35. The method of claim 33, wherein the prosodic behavior includes addition, to the first set of prosodic features, of an additional prosodic feature.

36. The method of claim 33, wherein the prosodic behavior includes a deletion of a subset of the prosodic features.

37. A computerized method of analyzing a discourse engaged in by a plurality of interacting agents, comprising:
a. during a first time interval, measuring a first set of prosodic features associated with the discourse;
b. at least partially based on the first set, determining a first state of the discourse associated with the first set; and
c. determining a change in the first set likely to incline the discourse away from the first state and toward a target state.

38. The method of claim 37, including conveying the change in the first set to a subset of the agents.

39. The method of claim 37, wherein determining the first state includes estimating the first state.

40. The method of claim 37, wherein determining the first state includes classifying the discourse by matching the first set of prosodic features to a subset of predetermined classes of prosodic behaviors.

41. The method of claim 40, wherein the classes of prosodic behaviors includes a previous prosodic behavior of a subset of the agents.

42. The method of claim 40, including determining a variation in a subset of the first set of prosodic features, the variation likely to change the matching.

43. The method of claim 37, including conveying to at least one of the agents information associated with the first state.

44. The method of claim 37, including conveying to at least one of the agents information associated with the target state.

45. The method of claim 37, including conveying to at least one of the agents information associated with at least a portion of the determined change in the subset of prosodic features.

46. The method of claim 37, including determining a variation in a subset of the prosodic features, the variation likely to change the first state.

47. A computerized method of selecting a subset of agents to participate in a discourse, comprising:
a. profiling a prosodic behavior of the agents based on at least one previous discourse engaged in by at least one of the agents; and
b. based at least partially on the profiling, selecting the subset of the agents having an associated prosodic behavior likely to produce a target state of the discourse.
